(19) United States
(12) Patent Application Publication
(10) Pub. No.: US 2026/0032384 A1
(43) Pub. Date: Jan. 29, 2026

(54) VEHICLE DYNAMIC SOUND OUTPUT APPARATUS AND METHOD

(71) Applicant: HYUNDAI MOBIS CO., LTD., Seoul (KR)

(72) Inventor: Hyung Sub LIM, Yongin-si (KR)

(73) Assignee: HYUNDAI MOBIS CO., LTD., Seoul (KR)

(21) Appl. No.: 19/230,342

(22) Filed: Jun. 6, 2025

(30) Foreign Application Priority Data
Jul. 23, 2024 (KR) 10-2024-0097229

(51) Int. Cl. H04R 3/04

(52) U.S. Cl. CPC H04R 3/04; H04R 2430/01; H04R 2430/03; H04R 2499/13

(57) ABSTRACT

A vehicle dynamic sound output apparatus, a method and a system therefor are provided. The vehicle dynamic sound output apparatus includes a sound source inputter to receive input of a sound source to be output to a vehicle, a sound source separator to separate individual elements of the received sound source and designate the individual elements as layers, a driving linkage setter to set a driving linkage element according to driving of the vehicle and design a linkage scenario according to the driving linkage element, a sound source tuner to tune the sound source based on the separated elements of the sound source and the linkage scenario, and a sound source outputter to output the tuned sound source.

### CROSS-REFERENCE TO RELATED APPLICATION(S)

This application claims the benefit under 35 USC § 119(a) of Korean Patent Application No. 10-2024-0097229, filed on Jul. 23, 2024, in the Korean Intellectual Property Office, the entire disclosure of which is hereby incorporated by reference for all purposes.

### BACKGROUND

### 1. Field

These embodiments relate to a vehicle sound output apparatus, and to a vehicle to which a vehicle dynamic sound output method weighted according to a driving situation is applied.

### 2. Description of the Related Art

Along with technological development and economic growth, automobiles, which are used as convenient means of transportation for people, have been developed beyond being simple means of transportation to provide driving safety, comfort, and enjoyment so that drivers may safely drive.

In general, a vehicle audio system is pre-tuned to optimize acoustic spatial response characteristics of the vehicle interior in which the audio system is installed.

However, frequency characteristics of the sound played by the vehicle audio system sensitively change depending on the surrounding environment in which vehicles are driven. When the frequency characteristics change in this way, it is necessary to adjust an equalizer of the audio system to compensate for the sound, which is not easy except for a listening expert.

### SUMMARY

Accordingly, the present disclosure is directed to a vehicle dynamic sound output apparatus and method that substantially obviate one or more problems due to limitations and disadvantages of the related art.

To solve the above-mentioned problem, one embodiment of the present disclosure provides a vehicle dynamic sound output apparatus configured to divide layers into individual sound source elements in a vehicle, tune the layer according to a driving situation, and output the layer.

The problems to be solved in the present disclosure are not limited to the technical problems mentioned above, and other technical problems not mentioned herein may be clearly understood by a person having ordinary skill in the technical field to which the present disclosure pertains from the description below.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In a general aspect, a vehicle dynamic sound output apparatus, includes: a sound source inputter configured to receive input of a sound source to be output to a vehicle; a sound source separator configured to separate individual elements of the received sound source and designate the individual elements as layers; a driving linkage setter configured to set a driving linkage element according to driving of the vehicle and design a linkage scenario according to the driving linkage element; a sound source tuner configured to tune the sound source based on the separated elements of the sound source and the linkage scenario; and a sound source outputter configured to output the tuned sound source.

The sound source separator may be further configured to: separate elements of the received sound source into at least one of vocals, each instrument, or each frequency band; and designate the elements as layers.

The driving linkage setter may be further configured to set a driving linkage element based on at least one of driving data or a driving situation of the vehicle.

The driving linkage setter may be further configured to: set information of at least one of a pedal value, a brake value, a speed value, or a torque value of the vehicle as a driving linkage element according to the driving data of the vehicle; and set a situation among rapid acceleration, rapid deceleration, smooth acceleration, smooth deceleration, and constant-speed driving, based on a speed of the vehicle as a driving linkage element according to the driving situation.

In response to at least one of a pedal value, a brake value, or a speed value being selected based on the driving data of the vehicle, the driving linkage setter may be further configured to select a layer for each frequency band according to each driving linkage element, wherein the sound source tuner may be further configured to: set a tuning point corresponding to a layer for each frequency band, and obtain a weighted sum thereof; and generate the tuned sound source.

In another general aspect, a vehicle dynamic sound output method includes: receiving input of a sound source to be output to a vehicle; separating individual elements of the received sound source and designating the individual elements as layers; setting a driving linkage element according to driving of the vehicle; designing a linkage scenario according to the driving linkage element; tuning the sound source based on the separated elements of the sound source and the linkage scenario; and outputting the tuned sound source.

The separating of individual elements may include separating elements of the received sound source into at least one of vocals, each instrument, or each frequency band and designating the elements as layers.

The setting of the driving linkage element may include setting a driving linkage element based on driving data or a driving situation of the vehicle.

The vehicle dynamic sound output method may further include: setting information of at least one of a pedal value, a brake value, a speed value, or a torque value of the vehicle as a driving linkage element according to the driving data of the vehicle; and setting a situation among rapid acceleration, rapid deceleration, smooth acceleration, smooth deceleration, and constant-speed driving, based on a speed of the vehicle as a driving linkage element according to the driving situation.

In response to at least one of a pedal value, a brake value, or a speed value being selected based on the driving data of the vehicle, the designing of the linkage scenario may include selecting a layer for each frequency band according to each driving linkage element, wherein the tuning of the sound source may include setting a tuning point corresponding to a layer for each frequency band and obtaining a weighted sum thereof, and generating the tuned sound source.

In yet another aspect, a vehicle dynamic sound output system, includes: a controller configured to obtain driving information of a vehicle; a sound source inputter configured to receive input of a sound source to be output to a vehicle; a sound source separator configured to separate individual elements of the received sound source and designate the individual elements as layers; a driving linkage setter configured to set a driving linkage element according to the driving information of the vehicle and design a linkage scenario according to the driving linkage element; a sound source tuner; and a sound source outputter, wherein the controller is further configured to control the sound source tuner to tune the sound source based on the separated elements of the sound source and the linkage scenario, and control the sound source outputter to output the tuned sound source.

The controller may be further configured to control an equalizer of the sound source tuner to compensate for changes in sound inside the vehicle.

The controller may be further configured to obtain the driving information from a driving information input interface based on manipulation by an occupant in the vehicle, wherein the driving information may be based on input to a user inputter in an autonomous driving mode or manual driving mode of a vehicle.

The driving information may include traveling information indicative of a driving state of the vehicle.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an overall block diagram of an autonomous driving control system to which an autonomous driving device according to any one of the embodiments of the present disclosure may be applied;

FIG. 2 is an example diagram illustrating an example in which the autonomous driving device according to any one of the embodiments of the present disclosure is applied to an autonomous vehicle;

FIG. 3 is a diagram for describing a vehicle dynamic sound output apparatus according to an embodiment of the present disclosure;

FIGS. 4 and 5 are diagrams for describing a driving linkage design scenario according to an embodiment of the present disclosure; and

FIG. 6 is a flowchart for describing a vehicle dynamic sound output method according to an embodiment of the present disclosure.

### DETAILED DESCRIPTION

Below, embodiments of the disclosure will be described in detail with reference to the accompanying drawings, so that a person having ordinary knowledge in the art to which the disclosure pertains can easily implement the disclosure. However, the disclosure may be implemented in various different forms and is not limited to the embodiments described herein. In addition, to clearly describe the disclosure, parts unrelated to the description are omitted from the drawings, and like numerals refer to like elements throughout the specification.

Throughout the specification, unless explicitly described to the contrary, the term “include” will be understood to imply the inclusion of stated elements but not the preclusion of any other elements, unless stated otherwise.

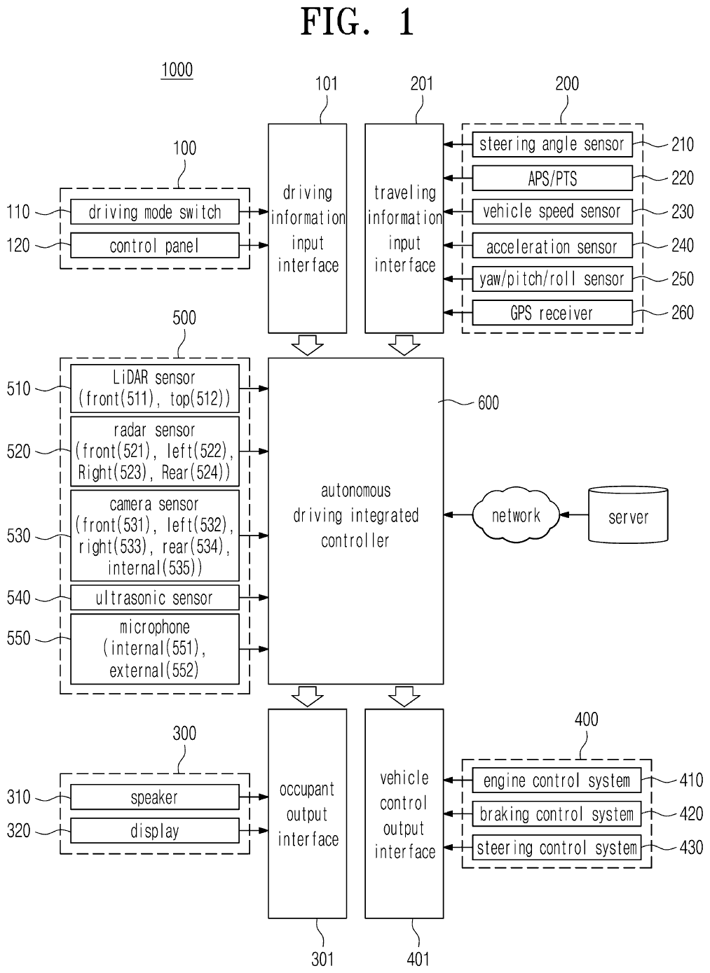

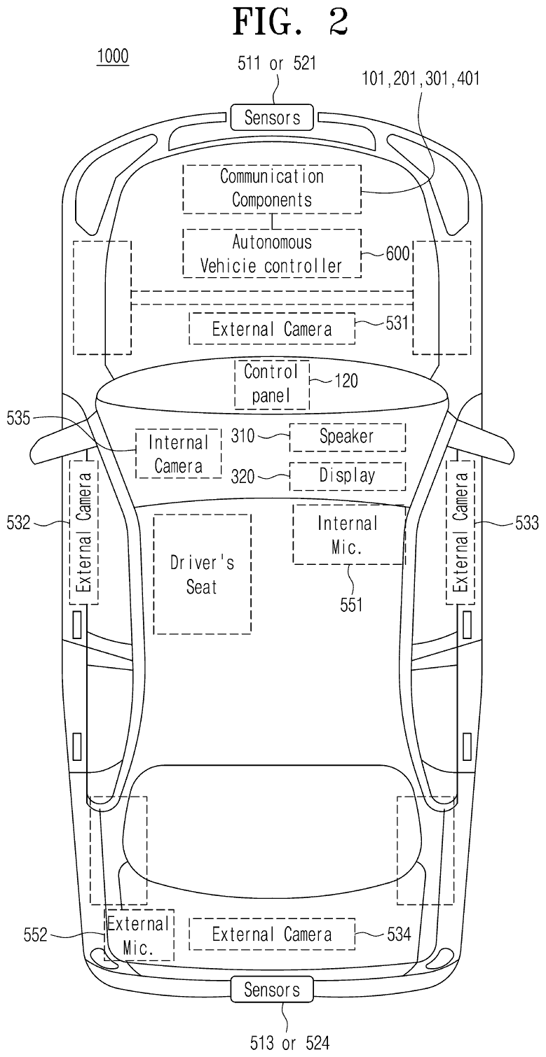

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LIDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LIDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LIDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

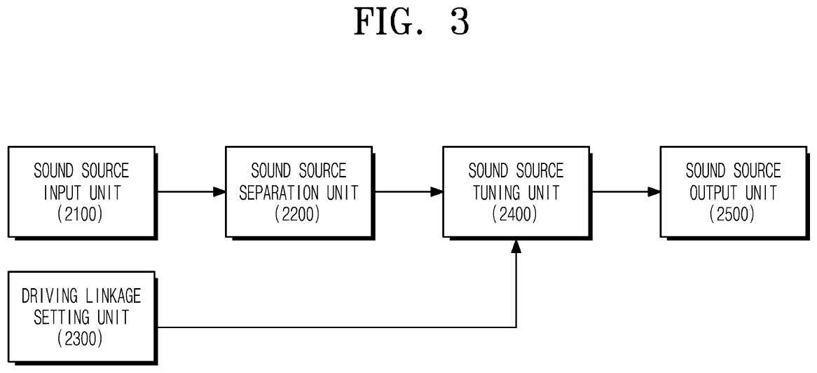

FIG. 3 is a diagram for describing a vehicle dynamic sound output apparatus according to an embodiment of the present disclosure.

Referring to FIG. 3, the vehicle dynamic sound output apparatus 2000 may include a sound source input unit 2100 (e.g., a sound source inputter), a sound source separation unit 2200 (e.g., a sound separator), a driving linkage setting unit 2300 (e.g., a driving linkage setter), a real-time sound source tuning unit 2400 (e.g., a sound source tuner), and a sound source output unit 2500 (e.g., a sound source outputter).

The sound source input unit 2100 may receive input of an original sound source to be output to the vehicle. The sound source input unit 2100 may receive input of a sound source through an AVN located in the vehicle.

The sound source separation unit 2200 may separate individual elements of the sound source input from the sound source input unit 2100 and designate the individual elements as layers.

The sound source separation unit 2200 may separate elements of the input sound source into vocals and individual instruments. Thereafter, the sound source separation unit 2200 may designate the elements corresponding to vocals and the individual instruments as layers.

For example, the sound source separation unit 2200 may separate a sound source by dividing layers for individual sound source elements such as a vocal sound, a guitar, drums, a piano, and a violin.

The sound source separation unit 2200 may separate elements of the input sound source into individual frequency bands. Thereafter, the sound source separation unit 2200 may designate an element corresponding to a frequency band as a layer.

For example, the sound source separation unit 2200 may divide the input sound source into a low-band layer of 500 Hz or less, a mid-band layer of 500 Hz to 4,000 Hz, and a high-band layer of 4,000 Hz to 20,000 Hz according to the frequency band. In other words, the sound source separation unit 2200 may divide the sound source of the low-band layer as a low-pitched sound, divide the sound source of the mid-band layer as a mid-pitched sound, and divide the sound source of the high-band layer as a high-pitched sound.

That is, the sound source separation unit 2200 may separate the input sound source elements into at least one of vocals, each instrument, or each frequency band and designate the sound source elements as layers.

The driving linkage setting unit 2300 may set a driving linkage element according to driving of the vehicle. The driving linkage setting unit 2300 may set the driving linkage element based on at least one of driving data or a driving situation of the vehicle.

The driving linkage setting unit 2300 may set a driving linkage element based on driving data. For example, the driving linkage setting unit 2300 may set at least one of a pedal value, a brake value, a speed value, or a torque value according to vehicle driving as the driving linkage element.

The driving linkage setting unit 2300 may set a driving linkage element based on a driving situation according to speed. For example, the driving linkage setting unit 2300 may set one of situations among rapid acceleration, rapid deceleration, smooth acceleration, smooth deceleration, and constant-speed driving based on speed of the vehicle as the driving linkage element according to the driving situation.

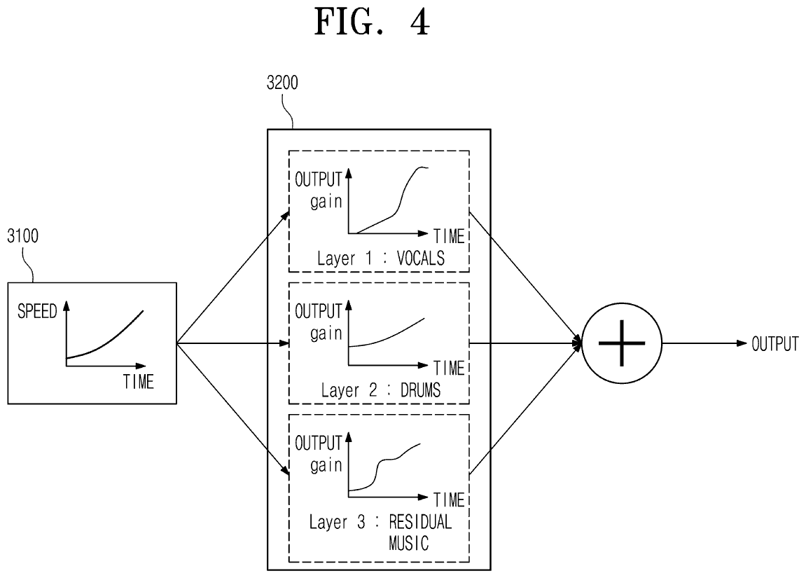

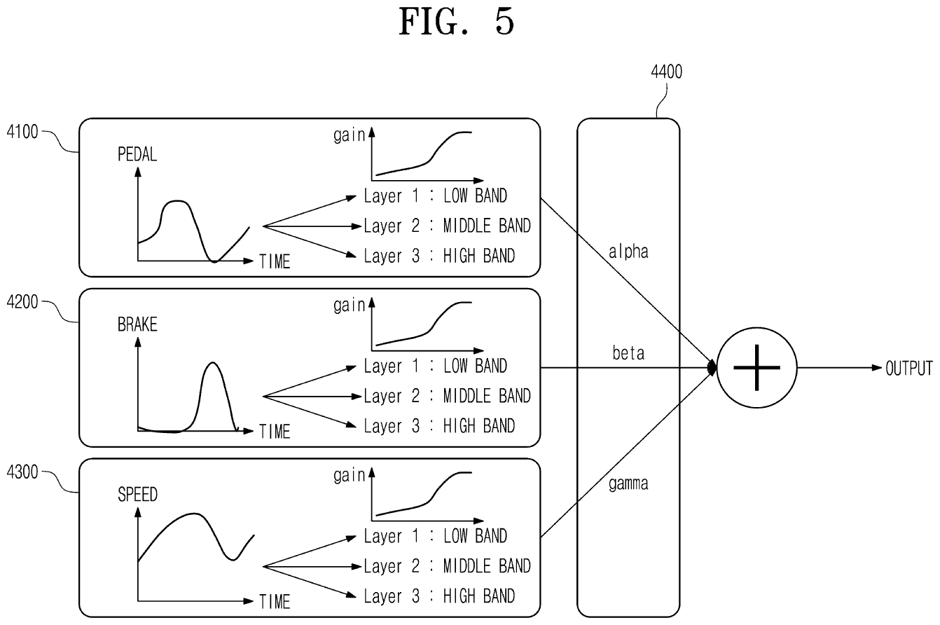

The driving linkage setting unit 2300 may design a linkage scenario according to each driving linkage element. The linkage scenario will be described in detail with reference to FIGS. 4 and 5 below.

The sound source tuning unit 2400 may tune the separated sound source according to the sound source element received from the sound source separation unit 2200 and the linkage scenario received from the driving linkage setting unit 2300. For example, the sound source tuning unit 2400 may set tuning points corresponding to layers of the separated sound source according to the linkage scenario and generate a tuned sound source through weighted sum thereof.

The sound source tuning unit 2400 may tune the input sound source in real time based on the linkage scenario of the driving linkage setting unit 2300.

The sound source output unit 2500 may output the sound source tuned by the sound source tuning unit 2400.

FIGS. 4 and 5 are diagrams for describing a driving linkage design scenario according to an embodiment of the present disclosure.

Referring to FIG. 4, the driving linkage setting unit 2300 may set a scenario for each driving situation.

The driving linkage setting unit 2300 may select a layer 3200 for each sound source element according to a rapid acceleration scenario 3100 when the vehicle speed rapidly increases over time.

For example, the driving linkage setting unit 2300 may select vocals as a first layer, drums as a second layer, and residual music as a third layer from the sound source elements.

The driving linkage setting unit 2300 may set output gain of the vocals, which are the selected first layer, over time.

The driving linkage setting unit 2300 may set output gain of the drums, which are the selected second layer, over time.

The driving linkage setting unit 2300 may set output gain of the residual music, which is the selected third layer, over time.

That is, the driving linkage setting unit 2300 may obtain a weighted sum of tuning points according to a layer for each sound source element and setting for each driving situation, and output the weighted sum.

Meanwhile, referring to FIG. 5, the driving linkage setting unit 2300 may set a scenario for each driving linkage element.

The driving linkage setting unit 2300 may set driving linkage elements as a pedal value, a brake value, and a speed value.

Upon receiving pedal value information over time, the driving linkage setting unit 2300 may select a layer 4100 for each frequency band of the sound source according to a pedal value.

For example, the driving linkage setting unit 2300 may select a low band as a first layer, a middle band as a second layer, and a high band as a third layer in a sound source bandwidth according to the pedal value. The driving linkage setting unit 2300 may set output gain of the low band, which is the selected first layer, over time. The driving linkage setting unit 2300 may set output gain of the middle band, which is the selected second layer, over time. The driving linkage setting unit 2300 may set output gain of the high band, which is the selected third layer, over time.

Upon receiving brake value information over time, the driving linkage setting unit 2300 may select a layer 4200 for each frequency band of the sound source according to a brake value.

For example, the driving linkage setting unit 2300 may select a low band as a first layer, a middle band as a second layer, and a high band as a third layer in a sound source bandwidth according to the brake value. The driving linkage setting unit 2300 may set output gain of the low band, which is the selected first layer, over time. The driving linkage setting unit 2300 may set output gain of the middle band, which is the selected second layer, over time. The driving linkage setting unit 2300 may set output gain of the high band, which is the selected third layer, over time.

Upon receiving speed information over time, the driving linkage setting unit 2300 may select a layer 4300 for each frequency band of the sound source.

For example, the driving linkage setting unit 2300 may select a low band as a first layer, a middle band as a second layer, and a high band as a third layer in a sound source bandwidth according to the speed. The driving linkage setting unit 2300 may set output gain of the low band, which is the selected first layer, over time. The driving linkage setting unit 2300 may set output gain of the middle band, which is the selected second layer, over time. The driving linkage setting unit 2300 may set output gain of the high band, which is the selected third layer, over time.

Accordingly, the sound source tuning unit 2400 may select tuning points 4400 according to a driving linkage element according to driving data and a layer for each frequency band of the sound source, obtain a weighted sum thereof, and generate a tuned sound source.

For example, the tuning points 4400 may include a tuning point (alpha) of the layer 4100 for each frequency band of the sound source according to the pedal value, a tuning point (beta) of the layer 4200 for each frequency band of the sound source according to the brake value, and a tuning point (gamma) of the layer 4100 for each frequency band of the sound source according to the pedal value.

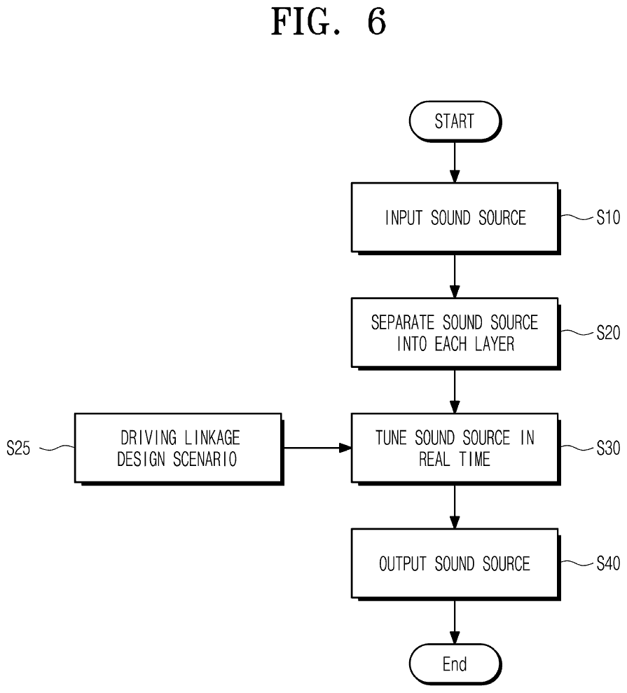

FIG. 6 is a flowchart for describing a vehicle dynamic sound output method according to an embodiment of the present disclosure.

Referring to FIG. 6, the vehicle dynamic sound output apparatus 2000 may receive input of a sound source (S10).

After step S10, the vehicle dynamic sound output apparatus 2000 may separate a sound source into each layer of the input sound source (S20). To this end, the vehicle dynamic sound output apparatus 2000 may separate layers based on sound source elements. In addition, the vehicle dynamic sound output apparatus 2000 may separate layers based on frequency bands of the input sound source.

After step S20, the vehicle dynamic sound output apparatus 2000 may tune the sound source separated into each layer (S30) based on a driving linkage design scenario (S25). For example, the vehicle dynamic sound output apparatus 2000 may tune the sound source in real time based on the driving linkage design scenario.

After step S30, the vehicle dynamic sound output apparatus 2000 may output the tuned sound source through a speaker (S40).

According to one embodiment of the present disclosure, even when acoustic spatial response characteristics of the vehicle interior change due to a surrounding environment of the vehicle, it is possible to provide reference-quality optimal sound to a listener.

Effects obtainable from the present disclosure are not limited to the effects mentioned above, and other effects not mentioned herein may be clearly understood by a person having ordinary skill in the art to which the present disclosure pertains from the above description.

That is, the technical idea of the present disclosure may be applied to the entire autonomous vehicle or may be applied to only some components inside the autonomous vehicle. The scope of the rights of the present disclosure should be determined according to the matters described in the patent claims.

As another aspect of the present disclosure, the operation of the proposal or proposal described above may be provided as code that may be implemented, performed or executed by a “computer” (a comprehensive concept including a system on chip (SoC) or a microprocessor, etc.), an application storing or including the code, a computer-readable storage medium, a computer program product, etc., which falls within the scope of the present disclosure.

The detailed description of the preferred embodiments of the present disclosure disclosed above has been provided to enable those skilled in the art to implement and practice the present disclosure. Even though a description has been given above with reference to the preferred embodiments of the present disclosure, it should be understood that those skilled in the art will understand that the present disclosure may be variously modified and changed without departing from the scope of the present disclosure. For example, those skilled in the art may utilize each of the configurations described in the above-described embodiments by combining the configurations.

Accordingly, the present disclosure is not intended to be limited to the embodiments shown herein but is to be accorded the widest scope consistent with the principles and novel features disclosed herein.

What is claimed is:

1. A vehicle dynamic sound output apparatus, comprising:
a sound source inputter configured to receive input of a sound source to be output to a vehicle;
a sound source separator configured to separate individual elements of the received sound source and designate the individual elements as layers;
a driving linkage setter configured to set a driving linkage element according to driving of the vehicle and design a linkage scenario according to the driving linkage element;
a sound source tuner configured to tune the sound source based on the separated elements of the sound source and the linkage scenario; and
a sound source outputter configured to output the tuned sound source.

2. The vehicle dynamic sound output apparatus according to claim 1, wherein the sound source separator is further configured to:
separate elements of the received sound source into at least one of vocals, each instrument, or each frequency band; and
designate the elements as layers.

3. The vehicle dynamic sound outputter according to claim 2, wherein the driving linkage setter is further configured to set a driving linkage element based on at least one of driving data or a driving situation of the vehicle.

4. The vehicle dynamic sound output apparatus according to claim 3, wherein the driving linkage setter is further configured to:
set information of at least one of a pedal value, a brake value, a speed value, or a torque value of the vehicle as a driving linkage element according to the driving data of the vehicle; and
set a situation among rapid acceleration, rapid deceleration, smooth acceleration, smooth deceleration, and constant-speed driving, based on a speed of the vehicle as a driving linkage element according to the driving situation.

5. The vehicle dynamic sound output apparatus according to claim 4,
wherein, in response to at least one of a pedal value, a brake value, or a speed value being selected based on the driving data of the vehicle, the driving linkage setter is further configured to select a layer for each frequency band according to each driving linkage element, and
wherein the sound source tuner is further configured to:
set a tuning point corresponding to a layer for each frequency band, and obtain a weighted sum thereof; and
generate the tuned sound source.

6. A vehicle dynamic sound output method comprising:
receiving input of a sound source to be output to a vehicle;
separating individual elements of the received sound source and designating the individual elements as layers;
setting a driving linkage element according to driving of the vehicle;
designing a linkage scenario according to the driving linkage element;
tuning the sound source based on the separated elements of the sound source and the linkage scenario; and
outputting the tuned sound source.

7. The vehicle dynamic sound output method according to claim 6, wherein the separating of individual elements comprises separating elements of the received sound source into at least one of vocals, each instrument, or each frequency band and designating the elements as layers.

8. The vehicle dynamic sound output method according to claim 7, wherein the setting of the driving linkage element comprises setting a driving linkage element based on driving data or a driving situation of the vehicle.

9. The vehicle dynamic sound output method according to claim 8, further comprising:
setting information of at least one of a pedal value, a brake value, a speed value, or a torque value of the vehicle as a driving linkage element according to the driving data of the vehicle; and
setting a situation among rapid acceleration, rapid deceleration, smooth acceleration, smooth deceleration, and constant-speed driving, based on a speed of the vehicle as a driving linkage element according to the driving situation.

10. The vehicle dynamic sound output method according to claim 9,
wherein, in response to at least one of a pedal value, a brake value, or a speed value being selected based on the driving data of the vehicle, the designing of the linkage scenario comprises selecting a layer for each frequency band according to each driving linkage element, and
wherein the tuning of the sound source comprises setting a tuning point corresponding to a layer for each frequency band and obtaining a weighted sum thereof, and generating the tuned sound source.

11. A vehicle dynamic sound output system, comprising:
a controller configured to obtain driving information of a vehicle;
a sound source inputter configured to receive input of a sound source to be output to a vehicle;
a sound source separator configured to separate individual elements of the received sound source and designate the individual elements as layers;
a driving linkage setter configured to set a driving linkage element according to the driving information of the vehicle and design a linkage scenario according to the driving linkage element;
a sound source tuner; and
a sound source outputter,
wherein the controller is further configured to:
control the sound source tuner to tune the sound source based on the separated elements of the sound source and the linkage scenario; and
control the sound source outputter to output the tuned sound source.

12. The vehicle dynamic sound output system according to claim 11, wherein the controller is further configured to control an equalizer of the sound source tuner to compensate for changes in sound inside the vehicle.

13. The vehicle dynamic sound output system according to claim 11, wherein the controller is further configured to obtain the driving information from a driving information input interface based on manipulation by an occupant in the vehicle, and
wherein the driving information is based on input to a user inputter in an autonomous driving mode or manual driving mode of a vehicle.

14. The vehicle dynamic sound output system according to claim 13, wherein the driving information includes traveling information indicative of a driving state of the vehicle.
